(19) United States
(12) Patent Application Publication
(10) Pub. No.: US 2020/0232680 A1
(43) Pub. Date: Jul. 23, 2020

(54) Method for conducting agricultural and industrial operations with reduced fossil fuel inputs

(71) Applicant: Kenneth Miles Hanson, Oaksdale, WA (US)

(72) Inventor: Kenneth Miles Hanson, Oaksdale, WA (US)

(21) Appl. No.: 16/746,800

(22) Filed: Jan. 17, 2020

Related U.S. Application Data
(60) Provisional application No. 62/793,815, filed on Jan. 17, 2019.

(51) Int. Cl. F24S 23/74; F24S 30/42

(52) U.S. Cl. CPC F24S 23/74; F24S 23/72; F24S 30/42

(57) ABSTRACT

A process of using thermal energy to decrease the external energy and imported inputs required to perform agricultural processes.

### CROSS-REFERENCE TO RELATED APPLICATIONS

This application claims priority to provisional application 62/793,815 filed on Jan. 17, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

Solar Thermal Collector

Parabolic trough power plants use a curved, mirrored trough which reflects the direct solar radiation onto a glass tube containing a fluid (also called a receiver, absorber or collector) running the length of the trough, positioned at the focal point of the reflectors. The trough is parabolic along one axis and linear in the orthogonal axis. For change of the daily position of the sun perpendicular to the receiver, the trough tilts east to west so that the direct radiation remains focused on the receiver. However, seasonal changes in the angle of sunlight parallel to the trough does not require adjustment of the mirrors, since the light is simply concentrated elsewhere on the receiver. Thus the trough design does not require tracking on a second axis. The receiver may be enclosed in a glass vacuum chamber. The vacuum significantly reduces convective heat loss.

A fluid (also called heat transfer fluid) passes through the receiver and becomes very hot. Common fluids are synthetic oil, molten salt and pressurized steam. The fluid containing the heat is transported to a heat engine where about a third of the heat is converted to electricity.

An enclosed trough architecture encapsulates the solar thermal system within a greenhouse-like glasshouse. The glasshouse creates a protected environment to withstand the elements that can negatively impact reliability and efficiency of the solar thermal system.

Lightweight curved solar-reflecting mirrors are suspended within the glasshouse structure. A single-axis tracking system positions the mirrors to track the sun and focus its light onto a network of stationary steel pipes, also suspended from the glasshouse structure. Steam is generated directly, using oil field-quality water; as water flows from the inlet throughout the length of the pipes, without heat exchangers or intermediate working fluids.

The steam produced is then fed directly to the field's existing steam distribution network, where the steam is continuously injected deep into the oil reservoir. Sheltering the mirrors from the wind allows them to achieve higher temperature rates and prevents dust from building up as a result of exposure to humidity.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

A process of using thermal energy to decrease the external energy and imported inputs required to perform agricultural processes.

### BRIEF DESCRIPTION OF THE SEVERAL VIEWS OF THE DRAWING

FIG. 1 shows a cross section of the applicant's invention when an energy source is to the right of the applicant's invention.

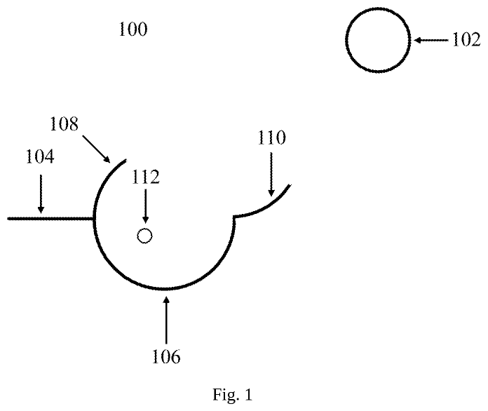

FIG. 2 shows a cross section of the applicant's invention when an energy source is substantially above the applicant's invention.

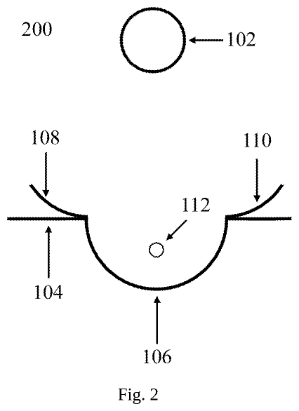

FIG. 3 shows a cross section of the applicant's invention when an energy source is to the left of the applicant's invention.

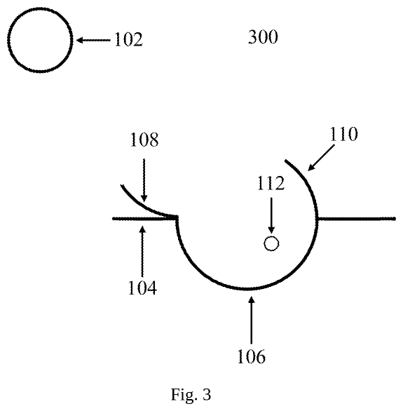

FIG. 4 shows a cross section of the applicant's invention being cleaned.

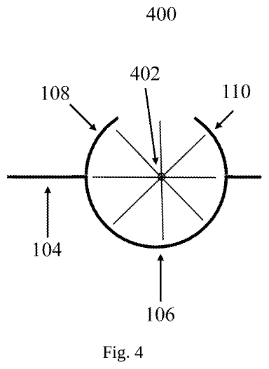

FIG. 5 shows a cross section of the applicant's invention when the retractable wings are deployed enclosing the concentrator.

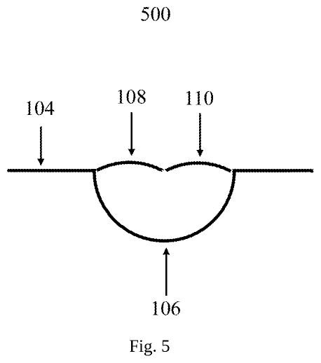

### DETAILED DESCRIPTION OF THE INVENTION

The applicant's system is an improved process for capturing, converting, and re-using waste energy with particular applicability to agricultural applications.

The applicant's system collects thermal energy from an available thermal energy source. In a preferred embodiment, the thermal energy source is solar energy.

In a preferred embodiment, thermal energy is collected using a curved trough, high-temperature, solar concentrator with an adjustable collector tube. The best known method of making and using a parabolic trough high temperature solar collector with adjustable collector tube is as follows:

Grade and compact the ground 104 on/in which the concentrator will be installed. Preferably the area will be made to have a 0.5% to 1.5% grade in a north-south direction to cause water to drain.

Excavate one or more rounded depressions/troughs generally corresponding to the shape of the desired concentrator. In a preferred embodiment, the length of the depression runs in the same direction as the grade so one end the trough is higher and the opposite end is lower. In a preferred embodiment, the rounded depression is semi-circular with a length greater than its width. In a first alternative embodiment, the depression is an arc of a circle. In a second alternative embodiment, the depression is “U” shaped. A rotary ditcher is preferably used to excavate the depression, though any means of creating the depression is within the scope of the present invention.

The soil defining the edge of the depression is preferably stabilized to prevent erosion and prevent soil from slumping toward the center and/or lower end of the depression. Exemplary methods of stabilizing the soil include, but are not limited to, applying a stabilizing solution, adding material to the soil (such as lime to soil high in clay), compacting the soil, and overlaying the soil with material.

A concentrator 106 in then installed in the depression. In a preferred embodiment, the concentrator 106 is formed into a shape matching the depression/trough and constructed as a single seamless piece (similar to continuous gutter). In a first alternative embodiment, the concentrator 106 is formed from a series of overlapping arc sections, each spanning the width of the depression (similar to adobe roof tiles). In a second alternative embodiment, the concentrator 106 is formed from a series of curved arc sections which, when combined, span the width of the depression. In a preferred embodiment, the concentrator 106 is made from polished stainless steel. In an alternative embodiment, the concentrator 106 is made from reflective flexible material such as stretched polyethylene terephthalate (PET).

A collector 112 is then installed in the concentrator 106. In a preferred embodiment, the collector 112 is a tube which runs approximately the length of the concentrator. In a preferred embodiment, the position of the collector 112 in the concentrator 106 is adjustable. The degree to which the position of the collector 112 relative to the concentrator 106 may be moved is selected based on the shape of the concentrator 106 to permit the collector 112 to be positioned at or near the focus of the concentrator as an energy source traverses the opening of the concentrator 106. In the case of a semi-circular concentrator 106, the collector 112 is preferably positioned approximately half-way between the center of the collector 106 and the surface of the collector 106 opposite the energy source. The diameter of the collector 112 is also chosen in conjunction with the dimensions of the concentrator 106 to permit the maximum amount of cost-effective energy to be collected. When the length of the concentrator 106 and collector 112 so indicate, the collector 112 is preferably supported at one or more points along the length of the collector.

In a preferred embodiment, the position of the collector 112 within the concentrator 106 is adjusted by an automatic controller. The automatic controller mechanically re-positions the collector 112, based on the position of the energy source, to maximize the energy reflected by the concentrator 106 onto the collector 112. The automatic controller may use sensors (such as, but not limited to, photo-voltaic sensors), to determine a position of the collector which would likely result in a maximal amount of energy being reflected by the concentrator 106 onto the collector 112 and position the collector 112 based on that input. The automatic controller may also use external data, such as sun position data, to determine a collector position which will likely result in maximum energy capture and position the collector 112 based on that data.

Fluid flows through the collector 112 where the fluid absorbs energy. The fluid is selected in conjunction with the geographic placement of the parabolic trough high temperature solar concentrator 106, the process selected to extract energy from the fluid, the speed at which the fluid will flow through the collector 112, and other factors which will affect the operating temperature and range of the fluid. In a preferred embodiment, the fluid flow is assisted by a pump. Thermal energy collected in the fluid, may be stored for later use, extracted from the fluid, or a combination of the two, in any currently known, or later developed, technology.

In a preferred embodiment, the concentrator 106 is further comprised of a one or more retractable wings 108 and 110. In a preferred embodiment, the concentrator wings are retractable such that, when deployed, the wings 108 and 110 extend the fixed portion of the collector 106 across a wider arc. When retracted, the wings 108 and 110 minimally block energy from reaching the fixed portion of the concentrator 106. When the energy source is at a wide angle, such as in 100 and 300, deploying a retractable wing opposite the energy source, 108 and 110 respectively, reflects more energy onto the collector. Retracting, or not deploying, the retractable wing adjacent the energy source, 108 and 110 respectively, permits the most available energy to reach, and be reflected by, the concentrator 106. The retractable wing(s) may be made from the same, or a different, material as the fixed portion of the concentrator 106.

In the morning 100 when the sun 102 is in the east, an eastern wing 110 is preferably retracted and a western wing 108 is preferably extended to allow a maximal amount of energy to enter the concentrator 106. During mid-day 200, when the sun 102 is coming from a direction in which the wings 108 and 110 would reduce energy entering the collector 106, by casting shadows 100, on the concentrator 106, both retractable wings 108 and 110 may be retracted to allow a maximal amount of energy to enter the collector 106. In the evening 300 when the sun 102 is in the west, an eastern wing 110 is preferably extended and a western wing 108 is preferably retracted to allow a maximal amount of energy to enter the concentrator 106.

In a preferred embodiment, the automatic controller which adjusts the position of the collector 112 in the concentrator 106 also retracts and deploys the retractable wing(s) 108 and 110, deploying a wing 108 or 110 when it will likely increase the energy reflected by the concentrator 106 onto the collector 112 and retracting a wing 108 or 110 when indicated to maximize the energy reflected by the concentrator 106 onto the collector 112. In a preferred embodiment, the retractable wings 108 and 110 may be automatically deployed and/or retracted for cleaning 400. Retractable wings 108 and 110 may also also be deployed 500 to reduce the amount of debris deposited in the concentrator 106 (such as by dust or snow storms), to prevent damage (such as by wind storms), and other purposes which maximize the efficiency of the system.

In a preferred embodiment, the collector trough 106 is cleaned by introducing water and/or a cleaning solution at the higher end of the concentrator 106. Since the concentrator is preferably installed on a slope, gravity causes the cleaning liquid to flow from the higher end to the lower end. In a preferred embodiment, the collector 112 is removable from the inside of the fixed concentrator 106. A brush 402, having approximately the same diameter as the concentrator 106 may then traverse the length of the concentrator 106 to aid in cleaning and debris removal 400. In a preferred embodiment, the retractable wings 108 and 110 are deployed, and therefore simultaneously cleaned, when the fixed concentrator 106 is cleaned. In a preferred embodiment, the control system which positions the collector 112 moves the collector 112 to a desired location which facilitates cleaning. In an alternative embodiment, the collector 112 is manually removed/re-located when cleaning the concentrator.

In a first alternative embodiment, thermal energy is collected and/or concentrated from a biomass. A variety of thermal energy sources ranging from geothermal, to biomass, to combusted syngas are well known in the art and may be substituted as a heat source without deviating from the core of the applicant's invention. If the heat source does not generate a sufficiently high temperature, a thermal concentration means, or heat from another source, may be used to reach the temperature necessary. In a preferred embodiment, the thermal concentration means is a high temperature heat pump (HTHP).

In a second alternative embodiment, one or more internal combustion engines is/are used as the thermal energy source. In a preferred embodiment, the internal combustion engines are adapted to operate on ammonia (NH₃). In a preferred embodiment, co-generation is used to extract a maximum amount of heat from the internal combustion engine(s).

In a preferred embodiment, the thermal energy is used to generate steam for, directly or indirectly, powering ammonia production using the Haber-Bosch process. In a first alternative embodiment, the thermal energy is used to generate electrical power. In a second alternative embodiment, the thermal energy is used to create hydrogen gas through thermochemical water splitting. In a third alternative embodiment, the thermal energy is used to make biochar. When the thermal energy is used to produce biochar, biochar outputs may be used in various combinations and permutations to fuel, promote, or as chemical inputs for processes (such as hydrogen production). In a preferred variation of this embodiment, biochar is produced using a high temperature process at approximately 1000° C. yielding approximately 15% carbon and 85% syngas. In a fourth alternative embodiment, the collected thermal energy is used to generate electricity. In a fifth alternative embodiment, the thermal energy is used to generate steam and then electricity by means of a steam turbine through an actual (non-ideal) Rankine cycle. In a sixth alternative embodiment, an organic Rankine cycle (ORC) is used to more efficiently convert thermal energy to kinetic energy at lower temperatures. In a seventh alternative embodiment, the thermal energy is used to create electricity by means of a Stirling Engine operating an electrical generator. In an eighth alternative embodiment, the thermal energy is converted into electricity by a Thermoelectric Generator (TEG). Any combination or permutation of thermal energy uses may be practiced within the scope of the invention.

In a preferred embodiment, generated electricity is used to generate, isolate, or concentrate chemical energy. In a preferred embodiment, the electricity is used to separate hydrogen from water through electrolysis. Electrolysis is well known in the art and an electrolyte is preferably added to the water creating an electrolyte solution to enable/speed the electrolysis. The electrolyte is preferably chosen based on the gas one wishes to collect. In a preferred embodiment, hydrogen is generated. Therefore, the electrolyte cation is selected from the following which have lower electrode potential than H+ and are therefore suitable for use as hydrogen generating electrolyte cations: Li+, Rb+, K+, Cs+, Ba2+, Sr2+, Ca2+, Na+, and Mg2+. Sodium and lithium are preferably used, as they form inexpensive, soluble salts.

In a first alternative embodiment, instead of using solar energy, heat and/or energy from an internal combustion engine is used (or to allow capital equipment to be used during non-sunlight hours) as the primary energy source. In a preferred embodiment the internal combustion engine is fueled with syngas, ethanol, ammonia, or other renewable or partially renewable fuel. In a preferred embodiment, exhaust heat from the internal combustion engine is used as a thermal energy source and/or chemicals in the exhaust are used as precursors for other processes such as ethanol production through biological processes.

In a second alternative embodiment additional heat is added to the system from an additional source. In this alternative embodiment, the heat may be collected through heat transfer solar. In an agricultural, or agricultural adjacent location these heat transfer solar collectors may be installed on on the corners of pivots (land not reached by center pivot irrigation systems).

In a preferred embodiment, groundwater is used as a low temperature source and/or heat sink for the Stirling Engine, TEG, Rankine cycle, and/or ORC (and/or any other process step which benefits from a high temperature differential, a low temperature source, and/or a heat sink).

When the thermal energy is used to create ammonia, the ammonia may be used as a fertilizer, may be sold for use by others, and may be used as an energy storage medium for other processes including, but not limited to, generating heat when solar energy is not available or is other wise insufficient. The ammonia may also be used to supplement, or replace, other fuels for machinery and or vehicles powered by internal combustion engines.

### SEQUENCE LISTING

Not Applicable

1. An energy collection apparatus comprising:
A) a concentrator configured to collect and reflect radiated energy
1. having a concave cross-section,
2. having a length greater than its width, and
3. installed in a depression formed in the ground,
B) a substantially hollow collector
1. disposed in said concentrator,
2. running approximately the length of said concentrator,
3. configured to collect radiated energy reflected by said concentrator; and
C) a fluid flowing occupying said substantially hollow collector.

2. The apparatus of claim 1 wherein:
A) said concentrator is movable within said concentrator.

3. The apparatus of claim 2 further comprising:
A) a control system which controls the position of said collector in said concentrator.

4. The apparatus of claim 3 wherein:
A) said collector is supported at a three or more locations along the length of the collector.

5. The apparatus of claim 3 further comprising:
A) a plurality of movable wings running substantially the length of the concentrator which:
1. reflect energy into said concentrator when in an extended position, and
2. minimally obstruct the entry of energy into said concentrator when in a retracted position.

6. The apparatus of claim 5 wherein:
A) said plurality of movable wings substantially cover and enclose said concentrator when in an extended position.

7. The apparatus of claim 5 further comprising:
A) a control system which controls the position of said plurality of movable wings.

8. The apparatus of claim 7 further comprising:
A) a pump configured to circulate fluid through said collector.

9. The apparatus of claim 8 wherein:
A) said collector is movable out of said concentrator.

10. The apparatus of claim 9 further comprising:
A) a brush, approximately the diameter of said concentrator, configured to traverse the length of said concentrator.

11. A method of installing a solar collection apparatus comprising:
A) smoothing an area to a gradual grade wherein the grade is selected to maximize solar exposure and promote fluid drainage,
B) forming a plurality of depressions having a length running in the same direction as the gradual grade,
C) stabilizing said plurality of depressions,
D) lining said plurality of depressions with an energy reflecting material thereby defining a concentrator,
E) installing a substantially hollow collector, running approximately the length of the concentrator, in the concentrator.
